(19) United States
(12) Patent Application Publication
(10) Pub. No.: US 2022/0233999 A1
(43) Pub. Date: Jul. 28, 2022

(54) DEVICE FOR COOLING AND DRYING AIR

(71) Applicant: AKG VERWALTUNGSGESELLSCHAFT MBH, Hofgeismar (DE)

(72) Inventors: Tom HAKENBECK, Kassel (DE); Harald KÖRNER, Reinhardshagen (DE); Hans-Jürgen PALM, Vellmar (DE); Bastian PÜHL, Trendelburg (DE)

(21) Appl. No.: 17/584,564

(22) Filed: Jan. 26, 2022

(30) Foreign Application Priority Data
Jan. 27, 2021 (DE) 20 2021 100 397.9

(51) Int. Cl. B01D 53/26; B01D 5/00

(52) U.S. Cl. CPC B01D 53/265; F28D 9/0075; B01D 5/009; B01D 5/0015

(57) ABSTRACT

A device for cooling and drying air, in particular for compressed air systems, includes an air/air heat exchanger having an air inlet and an air outlet, a refrigerant/air heat exchanger having a refrigerant inlet and a refrigerant outlet, and a condensate separator arranged between the air/air heat exchanger and the refrigerant/air heat exchanger. The condensate separator has a separation chamber having a condensate outlet. At least one lamella aligned inclined to a main flow direction of the air is arranged in the separation chamber for condensate separation.

### CROSS-REFERENCE TO RELATED APPLICATIONS

This application claims priority under 35 U.S.C. § 119 to German Patent Application No. DE 20 2021 100 397.9, filed on Jan. 27, 2021, the entire disclosure of which is herein expressly incorporated by reference.

### BACKGROUND AND SUMMARY OF THE INVENTION

Exemplary embodiments of the present invention relate to a device for cooling and drying air, in particular for compressed air systems.

A device of the type in question is known, for example, from U.S. Pat. No. 7,343,755 B2. Such devices essentially consist of an air/air heat exchanger and a refrigerant/air heat exchanger and a condensate separator integrated between the two heat exchangers.

To dry warm and humid air, in particular compressed air, this air, which is conducted out of a compressor, for example, is introduced into the air/air heat exchanger and pre-cooled there by the cool and dry air, which is conducted out of the condensate separator into the air/air heat exchanger. This pre-cooling can take place in the simple counter flow or meandering counter flow principle.

The air is subsequently guided through a closed duct from the air/air heat exchanger into the air/refrigerant exchanger and cooled there with the aid of the refrigerant, which flows in counter flow or meandering counter flow, to the dewpoint.

The moisture contained in the air then begins to condense here. The amount of the condensed liquid increases due to further cooling of the air to lower temperatures, so that a mixture of gaseous air and more or less fine liquid condensate droplets contained therein is present at the transition from the air/refrigerant heat exchanger to the condensate separator.

This mixture then flows into the condensate separator, in which the droplets are removed from the air flow. Gravity is sufficient for this purpose for larger droplets. For finer droplets, a contact of the droplets with wall surfaces, such as the inner walls of the condensate separator or a baffle is necessary. They initially remain adhered there and then flow, due to gravity, downward through a condensate outlet in the condensate separator.

Such devices have proven themselves per se in practice. The devices known from the prior art have the disadvantage that the humid air flow is always guided at high speed through the condensate separator for sufficient drying of the air and thus a part of the deposited moisture is entrained by the air flow.

Exemplary embodiments of the present invention are directed to a device for cooling and drying air, using which the above-mentioned disadvantages are remedied.

The device according to the invention has an air/air heat exchanger having an air inlet and an air outlet, a refrigerant/air heat exchanger having a refrigerant inlet and a refrigerant outlet, and a condensate separator arranged between the air/air heat exchanger and the refrigerant/air heat exchanger.

The condensate separator has a separation chamber having a condensate outlet. At least one lamella aligned inclined to a main through flow direction of the air for condensate separation is arranged in the separation chamber.

Using such a device it is now made possible for the air, which is to be cooled and dried, to be conducted at slower flow speed through the condensate separator, since due to the at least one lamella arranged in the separation chamber, a direct through flow, i.e., without direction change of the air flow, is prevented by the lamella and thus a sufficiently large proportion of the moisture is deposited on the lamella. From the lamella, the water condensed thereon can drain downward in the direction of the condensate outlet along the lamella and along the walls of the separation chamber.

According to one advantageous embodiment variant, the at least one lamella is held on mutually opposing side walls of a housing of the condensate separator.

Draining down of the condensate via the lamella along the side walls of the condensate separator is thus enabled in a simple manner.

According to one embodiment variant, the at least one lamella has a plurality of through flow openings.

According to one preferred refinement, the through flow openings are introduced here into lamella flanks of the lamella connected to one another by cam backs.

According to one preferred embodiment variant, the lamella flanks of the at least one lamella are aligned essentially perpendicular to the plane of the side walls of the housing of the condensate separator.

A direct flow through the lamella without direction change of the air flow is thus prevented.

According to a further preferred embodiment variant, the at least one lamella is aligned at an angle of 20° to 80° in relation to the opposing side walls of the housing.

This also enables reliable, rapid draining down of the condensed moisture away from the lamella toward the side walls of the housing.

According to a further preferred embodiment variant, webs protruding into the separation chamber are formed on the opposing side walls of the housing to fix the at least one lamella.

This enables the lamella to be pushed easily into the separation chamber during the assembly.

Two lamellae are particularly preferably arranged in the separation chamber.

According to one embodiment variant of the invention, a condensate collector is arranged in the region of the condensate outlet of the condensate separator.

According to one embodiment variant, this condensate collector is fastened on a housing outer wall of the condensate separator, in particular fastened by material bonding, in particular soldered or welded on.

According to an alternative embodiment variant, the condensate collector is formed integrated, in particular cast on, in a housing wall of the condensate separator having the condensate outlet.

The air/air heat exchanger, the refrigerant/air heat exchanger, and the condensate separator are preferably manufactured from aluminum. The device according to the invention is thus significantly lighter in relation to, for example, stainless steel heat exchangers.

Preferred exemplary embodiments are explained in more detail hereinafter on the basis of the appended figures.

### BRIEF DESCRIPTION OF THE DRAWING FIGURES

In the figures:

FIGS. 1 and 2 show schematic isometric illustrations of a first embodiment variant of a device according to the invention,

FIG. 3 shows an isometric exploded illustration of the device shown in FIGS. 1 and 2,

FIG. 4 shows a sectional view through a condensate separator of the device,

FIGS. 5 and 6 show top views of a frame of the heat exchanger having turbulator inserted therein,

FIG. 7 shows an isometric illustration of the condensate separator shown in FIG. 3 having lamellae arranged therein,

FIG. 8 shows a further isometric illustration of the condensate separator,

FIG. 9 shows an isometric illustration of an embodiment variant of the lamella arranged in the condensate separator,

FIGS. 10 to 12 show illustrations corresponding to FIGS. 1 to 3 of an embodiment variant of a device according to the invention,

FIG. 13 shows a sectional view corresponding to FIG. 4 through an alternative embodiment variant of a condensate separator having condensate collector integrated therein, and

FIGS. 14 to 18 show top views of different stack layers of the air/air heat exchanger and the air/refrigerant heat exchanger.

### DETAILED DESCRIPTION

In the following description of the figures, terms such as top, bottom, left, right, front, rear, etc. refer exclusively to the exemplary illustration and position selected in the respective figures of the air/air heat exchanger, refrigerant/air stacked shell heat exchanger, condensate separator, lamella, separation chamber, and the like. These terms are not to be understood as restrictive, i.e., these references can change due to various operating positions or mirror symmetrical design or the like.

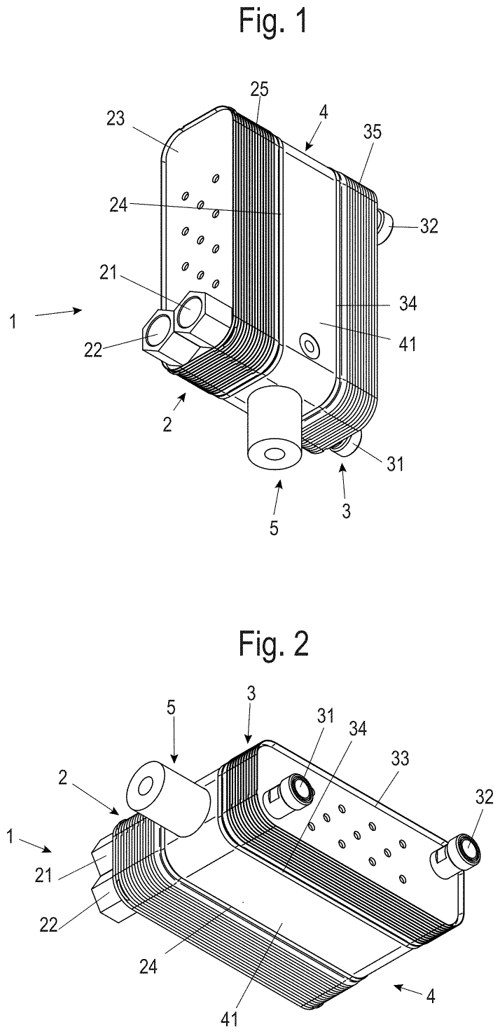

In FIGS. 1 to 3 and 10 to 12, a device for cooling and drying air, in particular for compressed air systems, designed here as a refrigeration dryer, is identified as a whole with the reference sign 1.

In both embodiment variants, the refrigeration dryer essentially consists of an air/air heat exchanger 2 having an air inlet 21 and an air outlet 22 and a refrigerant/air heat exchanger 3 having a refrigerant inlet 31 and a refrigerant outlet 32 and a condensate separator 4 arranged between the air/air heat exchanger 2 and the refrigerant/air heat exchanger 3.

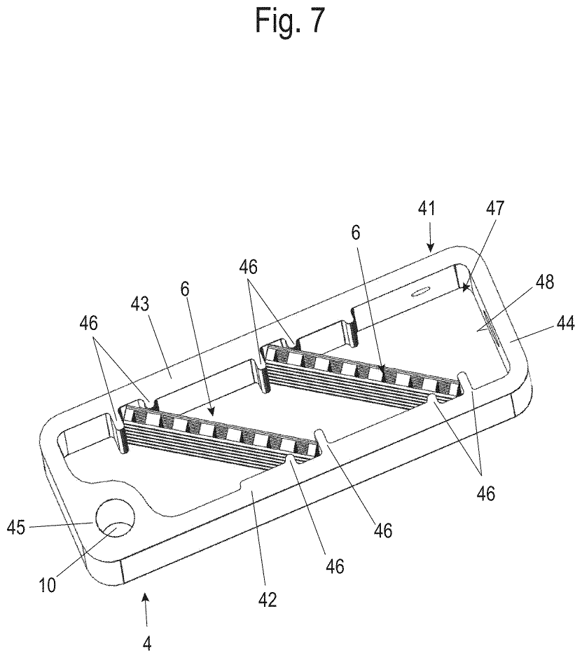

In the embodiment variant shown in FIGS. 1 to 6, both the air/air heat exchanger 2 and also the refrigerant/air heat exchanger 3 consist of a plurality of shells 7 stacked one on top of another, which are used in the case of the air/air heat exchanger 2 to conduct through two air flows, preferably in counter flow, and in the case of the refrigerant/air heat exchanger 3 are used for the through flow of a refrigerant, on the one hand, and an air flow, on the other hand, preferably also in the counter flow method.

The functionality in principle of the device corresponds to the functionality described in the introduction to the description on the basis of the prior art, in which warm and humid air, in particular compressed air, for example from a compressor, is introduced via an air inlet 21 into the air/air heat exchanger 2 and is precooled there by cool, dry air coming from the condensate separator 4.

Depending on the design of the individual shells 7 of the air/air heat exchanger 2, the precooling takes place in simple counter flow or also in the meandering counter flow principle.

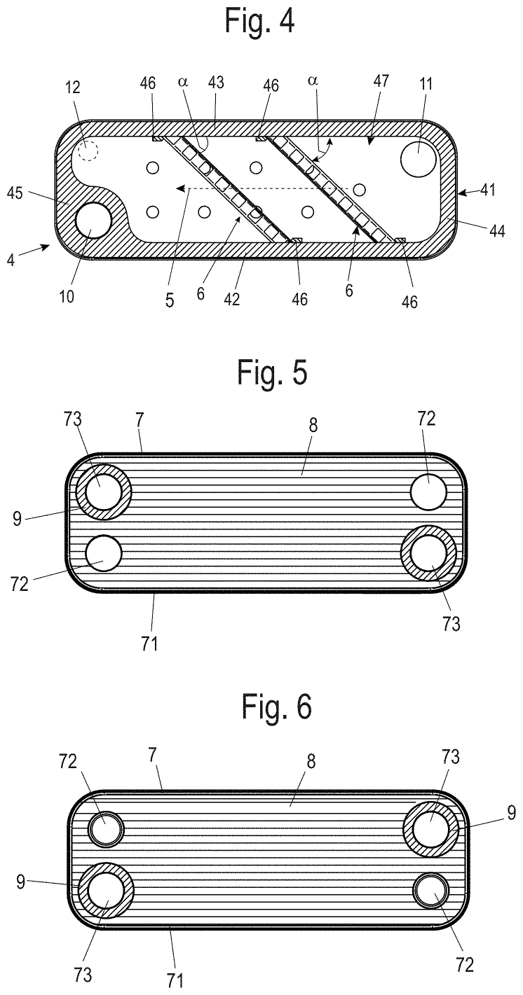

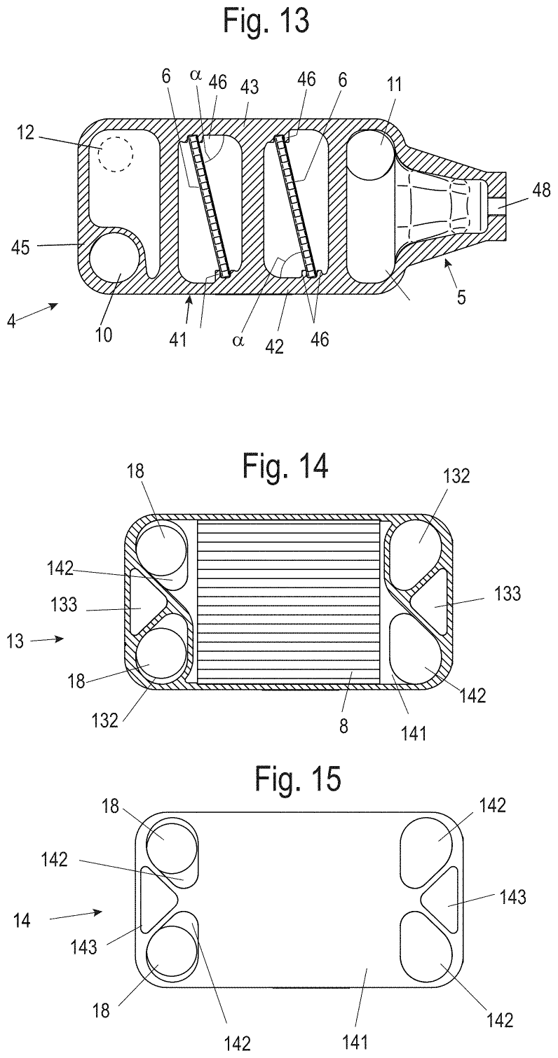

The precooled air subsequently passes through a tubular air passage 10 in one of the frontal housing walls 45 of the condensate separator 4, as shown by way of example in FIGS. 4 and 13.

From this air passage 10 in the condensate separator 4, the precooled air directly enters the refrigerant/air heat exchanger 3.

In the refrigerant/air heat exchanger 3, the air is also preferably guided in the counter flow principle on the refrigerant guided through the refrigerant/air heat exchanger 3 and thus cooled further.

The cold, humid air is subsequently guided via an air inlet 11, shown in FIG. 6, into a separation chamber 47 of the condensate separator 4.

At least one lamella 6 aligned at an angle to a main through flow direction S of the air is arranged for condensate separation in the separation chamber 47 of the condensate separator 4.

In the embodiment variants shown here according to FIGS. 4, 7, 8, and 13, two such lamellae 6 are arranged in the separation chamber 47. The two lamellae 6 are arranged at a predetermined distance in parallel to one another in the separation chamber 47.

The cold, humid air is guided in the separation chamber 47 through the lamellae 6 in the direction of an air outlet 12, shown in FIG. 6, leading out of the separation chamber 47.

As the cold, humid air flows through the separation chamber 47, the moisture condenses on the lamella 6 or the lamellae 6 and on the inner walls of the separation chamber 47. The separated condensate then flows along the lamella(e) 6 and along the side walls 42, 43 because of gravity in the direction of a condensate collector 5.

The cold, dry air then flows out of the separation chamber 47 through the air outlet 12 further into the air/air heat exchanger 2, where the cooled, dry air is then heated again by counter flow with the humid, warm air and is supplied again through the outlet 22 to the compressor or a compressed air network.

As shown in FIGS. 4, 7, 8, and 13, the lamellae 6 are held on mutually opposing side walls 42, 43 of a housing 41 of the condensate separator 4. For this purpose, webs 46 protruding into the separation chamber 47 are preferably formed on opposing side walls 42, 43 of the housing 41 to fix the lamellae 6.

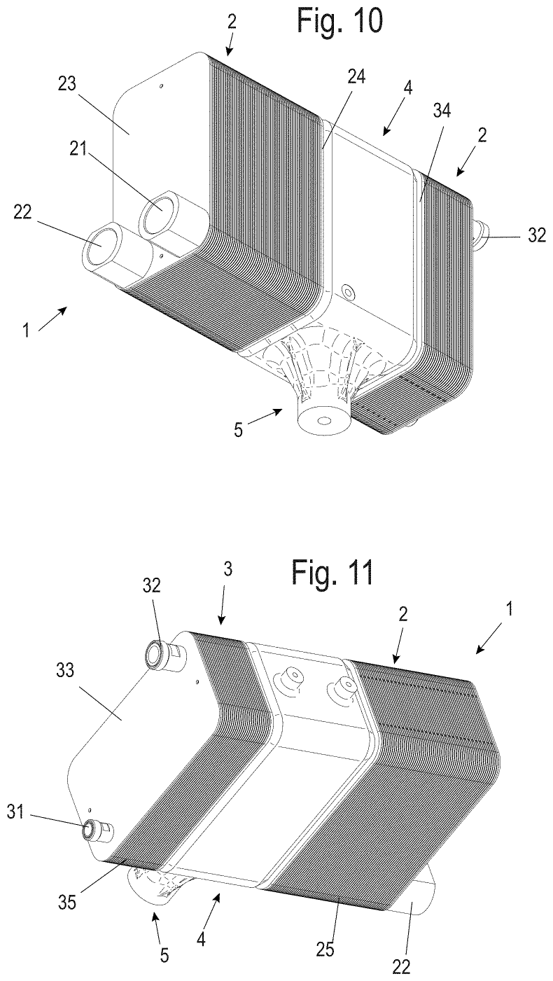

An embodiment variant of such a lamella 6 is shown in detail in FIG. 9.

As can be seen well in this figure, the lamella 6 has a plurality of lamella flanks 61 connected to one another by cam backs 62. A plurality of through flow openings 63 are formed in the lamella flanks 61.

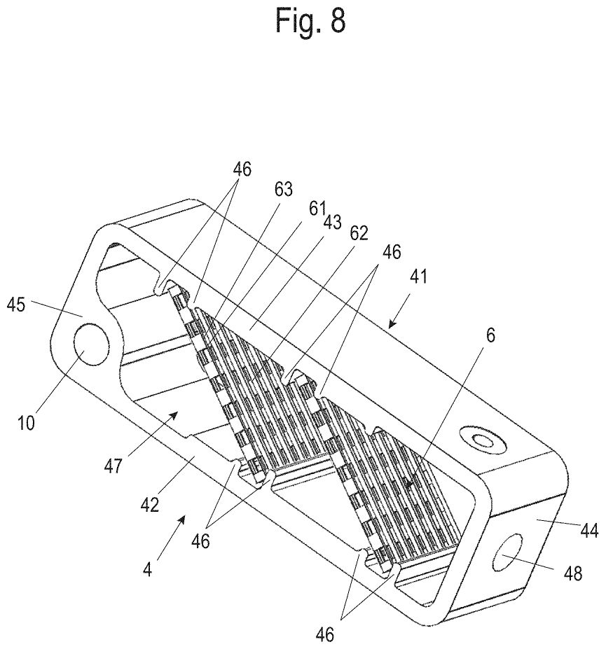

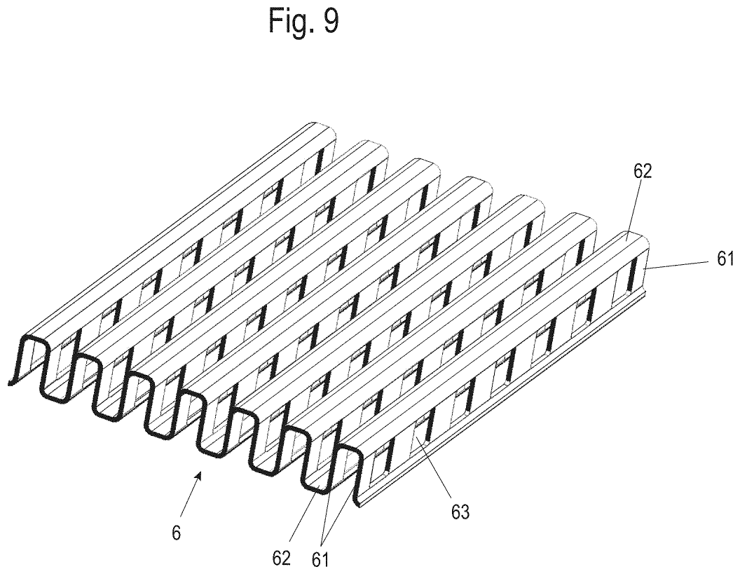

As is furthermore shown in FIGS. 7 and 8, the lamellae 6 are installed in the separation chamber 47 of the condensate separator 4 so that the lamella flanks 61 of the lamellae 6 are aligned essentially perpendicular to the plane of the side walls 42, 43 of the housing 41 of the condensate separator 4.

This means that the cold, humid air flowing out of the air inlet 11 into the separation chamber 47 strikes on the cam backs 62 of the lamellae 6 on its path in the main through flow direction S and has to flow further upward or downward perpendicular to the main through flow direction S for the continued flow through the lamella 6 through the through flow openings 63, in order to pass through the through flow openings 63 in the lamella flanks 61 of the lamella 6.

Because of this, the average flow speed of the air is significantly reduced in relation to the flow speed of the refrigeration dryer mentioned in the document cited in the introduction to the description and is preferably in a range below 1.5 m/s.

One positive effect of this slow through flow speed is that deposited condensate is not entrained with the air flow due to the air flow and thus does not result in renewed moisture enrichment of the air.

To promote draining down of the condensate condensed on the lamella 6, the lamellae 6 are preferably aligned at an angle α of 20° to 80° in relation to one another with respect to the opposing side ends 42, 43 of the housing 41. In the embodiment variants shown here, the set angle α is approximately 45°.

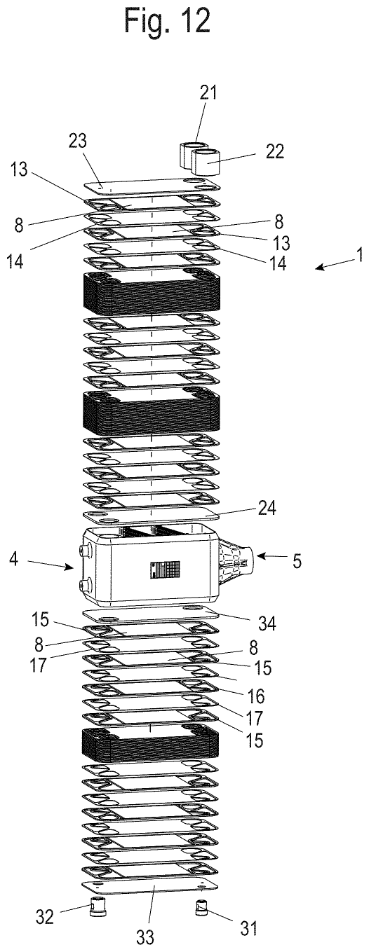

The embodiment variant according to FIGS. 1 to 6 differs from the embodiment variant of the refrigeration dryer 1 shown in FIGS. 10 to 18, firstly, due to the inserted shells of the air/air heat exchanger 2 and the refrigerant/air heat exchanger 3 and, secondly, due to the type of the arrangement of the condensate collector 5.

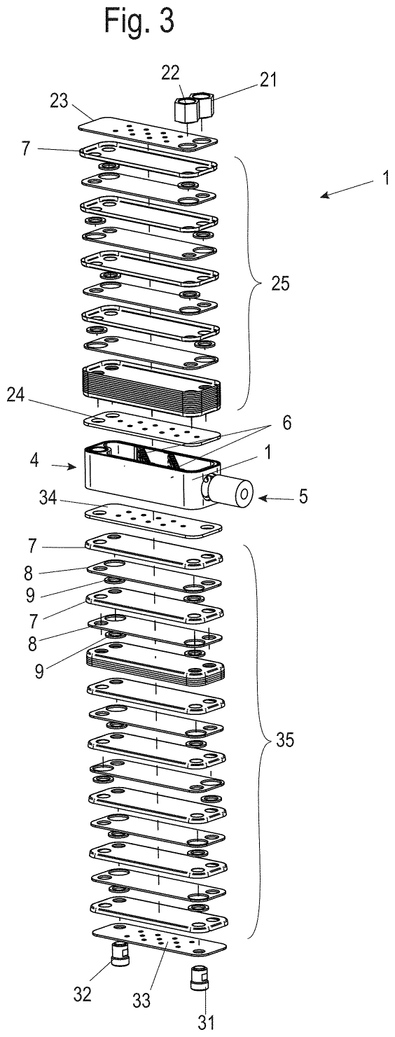

While in the first embodiment variant shown on the basis of FIGS. 3, 7, and 8, the condensate collector 5 is fastened on a housing outer wall of a frontal housing wall 44 of the condensate separator 4, in particular by material bonding, preferably soldered or welded on, in the second embodiment variant, shown in FIGS. 10 to 13, the condensate collector 5 is formed integrated into a housing wall 44 of the condensate separator 4 having the condensate outlet 48.

The condensate collector 5 is in particular also cast on during production of the housing 41 of the condensate separator 4 here.

Via a condensate outlet 48 of the condensate separator 4, in the embodiment variant shown in FIGS. 1-3, 7, and 8, the condensate is conducted out of the separation chamber 47 into the condensate collector 5.

In the embodiment variant shown in FIGS. 10 to 13, the condensate collector 5 forms the bottom region of the separation chamber 47. The condensate outlet 48 is formed as an opening here at the lower end of the condensate collector 5, to discharge the collected condensate.

Both embodiment variants of refrigeration dryers 1 share the feature that the air/air heat exchanger 2, the refrigerant/air heat exchanger 3, and the condensate separator 4 are preferably manufactured from aluminum.

In the embodiment variant of the refrigeration dryer 1 shown in FIGS. 1 to 6, the air/air heat exchanger 2 and the refrigerant/air heat exchanger 3 consist of a plurality of shells 7 stacked one on top of another, having a frame 71, a turbulator 8 inserted in the frame 71, and passages 72, 73 provided in the turbulator 8 and a shell bottom 74.

To control which of the air flows conducted through the air/air heat exchanger 2 are to flow through the respective shell 7, sealing rings 9 are provided, which are inserted between a lower side of a shell bottom 74 and the upper side of an opening provided in the turbulator 8 and thus conduct the air flowing in through the respective opening 72 or 73 through the respective shell 7 directly into the shell 7 arranged above or below it.

In the embodiment variant shown in FIGS. 10 to 18, the shells 7 are replaced by frames 13, 15, 16 and partition plates 14, 17.

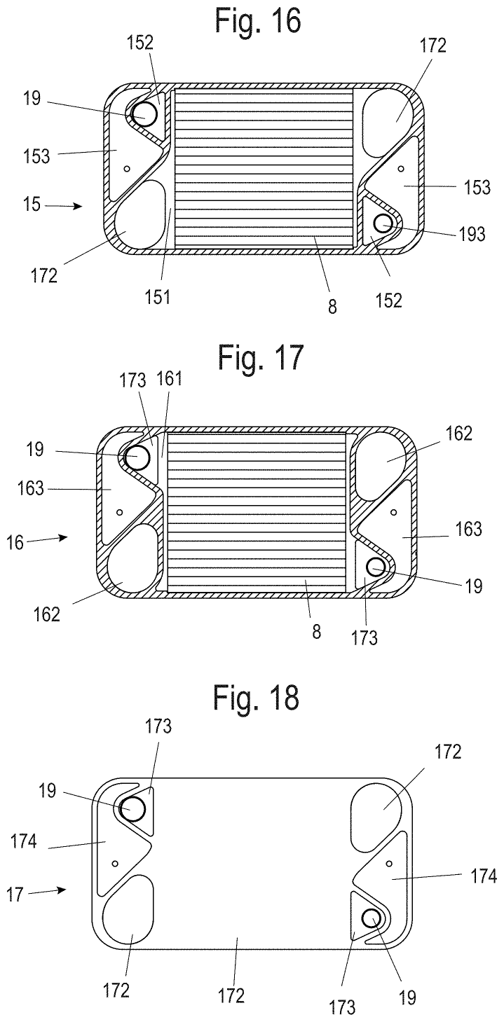

As shown in FIGS. 14 to 18, each of the frames 13, 15, and 16 forms a plurality of chambers. Partition plates 14, 17 are arranged above and below the respective frames 13, 15, 16.

The arrangement of the frames 13, 15, 16 and partition plates 14, 17 is also used to control the through flow of the two air flows in the air/air heat exchanger 2 or the through flow of the refrigerant and the air in the refrigerant/air heat exchanger 3, respectively.

Each of the frames 13, 15, 16 essentially has one through flow chamber 131, 151, 161 in which a turbulator 8 is preferably inserted.

The same frame 13 can always be used in all layers in the air/air heat exchanger 2, as shown in FIG. 12. The frame 13 is formed here so that the through flow chamber 131 is expanded at diagonally opposing ends so that an air duct 18 opens into the through flow chamber 131.

The frame 13 furthermore forms a closed chamber 132, so that an air duct 18 opening into this chamber 132 is conducted through the frame 13 to the frame 13 located above it or located below it, without reaching the region of the through flow chamber 131.

The frame 13 and also the frames 15 and 16 furthermore also have leak chambers 133, 153, 163, to be able to discharge possibly occurring leaks through a leak duct.

The partition plate 14 used in the air/air heat exchanger 2 has air passages 142 in the plate 141 of the partition plate 14 in the region of its corners. The partition plate 14 also has leak passages 143, which are arranged above or below the leak passages 133, 153, 163 of the frames 13, 15, 16, respectively.

Two differently formed frames 15, 16 are used in the refrigerant/air heat exchanger 3. The essential difference in these frames 15, 16 is that in a first frame 15, the refrigerant duct opens into a closed chamber 152 and the refrigerant thus cannot reach into the through flow chamber 151 of this frame 15.

In the frame 15, air accordingly flows through the through flow chamber 151, which is provided by air passages 172 in the partition plate 17 arranged above or below it, as shown in FIG. 18.

The further frame 16 shown in FIG. 17 is constructed so that the refrigerant duct 19 opens into the through flow chamber 161 of the frame 16 and the refrigerant thus flows through the frame 16, while the air passage 172 is framed in the frame 16 by a closed chamber 162, so that the air is only conducted vertically through the frame 16, without being able to reach into the through flow chamber 161.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 refrigeration dryer
2 air/air heat exchanger
21 air inlet
22 air outlet
23 cover plate
24 bottom plate
25 stack
3 refrigerant/air heat exchanger
31 refrigerant inlet
32 refrigerant outlet
33 cover
34 bottom
35 stack
4 condensate separator
41 housing
42 side wall
43 side wall
44 housing wall
45 housing wall
46 web
47 separation chamber
48 condensate drain
49 passage
5 condensate collector
6 lamella
61 lamella flank
62 cam
63 through flow opening
7 shell
71 frame
72 passage
73 passage
74 shell bottom
8 turbulator
9 sealing ring
10 air passage
11 air inlet
12 air outlet
13 frame
131 through flow chamber
132 chamber
133 leak chamber
14 partition plate
141 plate
142 air passage
143 leak passage
15 frame
151 through flow chamber
152 chamber
153 leak chamber
16 frame
161 through flow chamber
162 chamber
163 leak chamber
17 partition plate
171 plate
172 air passage
173 refrigerant passage
174 leak passage
18 air duct
19 refrigerant duct
S main through flow direction
α angle

1. A device for cooling and drying air, the device comprising:
an air/air heat exchanger having an air inlet and an air outlet;
a refrigerant/air heat exchanger having a refrigerant inlet and a refrigerant outlet;
a condensate separator arranged between the air/air heat exchanger and the refrigerant/air heat exchanger, wherein the condensate separator has a separation chamber having a condensate outlet, and wherein at least one lamella, which is aligned inclined to a main flow direction of air is arranged in the separation chamber to separate condensate.

2. The device of claim 1, wherein the at least one lamella is held on mutually opposing side walls of a housing of the condensate separator.

3. The device of claim 2, wherein the at least one lamella has a plurality of through flow openings.

4. The device of claim 3, wherein the through flow openings pass through lamella flanks of the lamella connected to one another by cam backs.

5. The device of claim 4, wherein the lamella flanks of the at least one lamella are aligned perpendicular to a plane of the mutually opposing side walls of the housing of the condensate separator.

6. The device of claim 2, wherein the at least one lamella is aligned at an angle of 20° to 80° in relation to the mutually opposing side walls of the housing.

7. The device of claim 2, wherein the mutually opposing side walls of the housing include webs protruding into the separation chamber to fix the at least one lamella.

8. The device of claim 1, wherein the at least one lamella is two lamellae.

9. The device of claim 1, further comprising:
a condensate collector arranged in a region of the condensate outlet of the condensate separator.

10. The device of claim 9, wherein the condensate collector is fastened on a housing outer wall of the condensate separator by soldering or welding.

11. The device of claim 9, wherein the condensate collector is formed integrated in a housing wall of the condensate separator having the condensate outlet.

12. The device of claim 1, wherein the air/air heat exchanger, the refrigerant/air heat exchanger, and the condensate separator are comprised of aluminum.
